(19) United States
(12) Patent Application Publication
(10) Pub. No.: US 2023/0182207 A1
(43) Pub. Date: Jun. 15, 2023

(54) ADDITIVE MANUFACTURING METHODS AND APPARATUS FOR FORMING OBJECTS FROM A NICKEL-BASED SUPERALLOY IN A LAYER-BY-LAYER MANNER

(71) Applicant: RENISHAW PLC, Wotton-under-Edge, Gloucestershire (GB)

(72) Inventors: Mathieu BROCHU, Montreal (CA); Sila Ece ATABAY, Montreal (CA); Oscar Sanchez MATA, Montreal (CA); Xianglong WANG, Montreal (CA); Jose Alberto Muniz LERMA, Montreal (CA)

(73) Assignee: RENISHAW PLC, Wotton-under-Edge, Gloucestershire (GB)

(21) Appl. No.: 17/924,557

(22) PCT Filed: May 18, 2021
(86) PCT No.: PCT/GB2021/051193

§ 371 Date: Nov. 10, 2022

(30) Foreign Application Priority Data
May 21, 2020 (GB) 2007591.7

(51) Int. Cl. B22F 10/366; B22F 10/28; B22F 10/38; C22C 19/05

(52) U.S. Cl. CPC B22F 10/366; B22F 10/28; B22F 10/38; C22C 19/057; B33Y 10/00

(57) ABSTRACT

An additive manufacturing method wherein an object is formed by selectively solidifying layers of powder with at least one energy beam. The method includes forming the object from a nickel-based superalloy, wherein exposure parameters and an exposure pattern for the at least one energy beam result in the object having a directionally solidified microstructure with columnar grains aligned with a build direction, perpendicular to the layers. A composition of the nickel-based alloy by weight % may include: 9.3-9.7W, 9.0-9.5Co, 7.5-8.5Cr, 5.4-5.7Al, 3.1-3.3Ta, 1.4-1.6Hf, 0.6-0.9Ti, Mo 0.4-0.6, 007-0.015Zr, 0.01-0.02B with a carbon concentration of around 0.07-0.09 wt % and a balance of Ni.

### FIELD OF INVENTION

This invention concerns additive manufacturing methods and apparatus for forming objects from a nickel-based superalloy in a layer-by-layer manner. The invention particularly concerns powder bed fusion additive manufacturing methods and apparatus for forming objects from a nickel-based superalloy, such as CM 247 LC.

### BACKGROUND

A superalloy is a metallic alloy which can be used at high temperatures, often in excess of 0.7 of the absolute melting temperature. Superalloys can be based on iron, cobalt or nickel, the latter being best suited for aeroengine applications.

The major alloying elements in nickel-based superalloys are aluminium and/or titanium, with a total concentration which is typically less than 10 atomic percent, (other elements, such as chromium, can be as high as 22%). This generates a two-phase equilibrium microstructure, consisting of gamma and gamma-prime phases. It is the gamma-prime phase which is largely responsible for the elevated temperature strength of the material and its increased resistance to creep deformation. Both the gamma and gamma-prime phases have a cubic lattice with similar lattice parameters and the gamma-prime precipitates in a cube-cube orientation relationship with the gamma phase. However, whereas the gamma phase is a solid-solution with a face-centred cubic lattice with a random distribution of the different species of atoms, the gamma-prime is a solid phase with a primitive cubic lattice, in which the nickel atoms are at the face-centres and the aluminium or titanium atoms at the cube corners. Due to the atomically ordered gamma-prime phase, dislocations in the gamma-phase have difficulty to cross/shear the gamma-prime phase, strengthening the alloy.

In addition to nickel, aluminium and titanium, superalloys may contain chromium for oxidation resistance, small quantities of yttrium to help the oxide scale to cohere to the substrate, for polycrystalline superalloys, grain strengthening elements, such as boron and zirconium. Carbide formers (cobalt, chromium, molybdenum, tungsten, carbon, niobium. tantalum, titanium and hafnium) may be included. The carbide formers tend to precipitate at the grain boundaries, reducing the tendency of grain boundary sliding.

Elements such as cobalt, iron, chromium, niobium, tantalum, molybdenum, tungsten, vanadium, titanium and aluminium are also solid-solution strengtheners, both in the gamma and gamma-prime phase.

Single-crystal superalloys (CMSX2, CMSX4, CMSX6, CMSX10, Rene N5, Rene N6, RR2000, RR3000, UCSX1, SRR99, TMS63, TMS75, TMS138, TMS162) can be cast using a spiral grain selector to form a part free from grain boundaries (i.e. a part formed as a single-crystal). Grain boundaries are easy diffusion paths and therefore reduce the resistance of the part to creep deformation. Hence, such single-crystalline parts exhibit high strength and creep resistance at elevated temperatures. However, such parts are difficult to manufacture with high failure rates in the production process.

Superalloys, such as CM247LC, MarM247, IN792, TMD-103, MarM200Hf, can be cast having a directionally solidified columnar grain structure, with grain boundaries that are mostly parallel to the major axis. The performance of such parts is not as good as single-crystalline parts but is better than parts formed with an equiaxed grain structure.

Powder bed fusion additive manufacturing methods for producing objects comprise layer-by-layer solidification of a powder, such as a metal powder material, using a high energy beam, such as a laser or electron beam. A powder layer is deposited on a powder bed in a build chamber and the laser or electron beam is scanned across portions of the powder layer that correspond to a cross-section of the object being constructed. The laser or electron beam melts the powder to form a solidified layer. After selective solidification of a layer, the powder bed is lowered by a thickness of the newly solidified layer and a further layer of powder is spread over the surface and solidified, as required.

US2011/0134952 A1 discloses a method of manufacturing components having directionally solidified or single crystal microstructures in a direct laser metal sintering system. The method includes depositing metal powder over a nickel-base superalloy seed crystal, such as CMSX-486, MAR-M-247, SC180, CMSX3, CMSX4 and CMSX486, having a predetermined primary orientation, scanning an initial pattern into the metal powder to melt or sinter the deposited metal powder, and rescanning the initial pattern to remelt the scanned metal powder and form an initial layer having the predetermined primary orientation.

WO2014/13114444 A1 describes an apparatus for producing a three-dimensional workpiece by selective laser melting comprising a control unit adapted to control the operation of the powder application device and the irradiation device in order to generate a desired microstructure, i.e. either a polycrystalline globulitic microstructure or a directionally/dendritically solidified microstructure comprising substantially dendrites and/or single crystals.

US2014/0305368 A1 discloses a method for manufacturing a component of a single crystal or a directionally solidified material, for example CMSX-4, CMSX-10, CMSX-12, CM186DS, MAR M 247, Inconel DS6203 or SCA427. The method includes superimposing a powder layer of a first material onto a surface of a substrate made out of the same single crystal or directionally solidified material and melting the powder layer into the substrate. During the solidification and transforming process the substrate acts as a crystal nucleus and the material of the layer adopts the same grain orientation as the grain orientation of the substrate. A slow cooling process of the material of the melt pool will support a proper growth of crystals of the material.

EP2737965 A and EP2772329 A1 disclose additive manufacturing methods, wherein primary and secondary crystallographic grain structures are controlled. The material used in the additive manufacturing process may be Waspaloy, Hastelloy, IN617, IN718, IN625, Mar M247, IN100, IN738, IN792, Mar M200, B1900, RENE 80, Alloy 713, Haynes 230 or Haynes 282.

US2016/0158889 A1 discloses a method of forming or repairing a superalloy article having a columnar or equiaxed or directionally solidified or amorphous or single crystal microstructure.

EP3459654 A1 discloses a method for producing or repairing a three-dimensional workpiece, wherein the workpiece is formed from a substrate having a substantially single-crystalline microstructure and the irradiation is controlled so as to maintain the single-crystalline microstructure. In an example, the powder material was IN718 and the single-crystal substrate was made of IN738LC.

WO2018/029478 A1 discloses an additive manufacturing system in which a sequence of energy pulses is determined to achieve a cooling rate that results in a specified microstructure, such as dendritic or cellular.

WO2018/086882 A1 discloses a method for producing or repairing a three-dimensional workpiece, wherein the workpiece is formed from a substrate having a substantially single-crystalline microstructure and the irradiation is controlled so as to maintain the single-crystalline microstructure. In an example, the powder material and the single-crystal substrate is IN738LC.

“Excellent mechanical and corrosion properties of austenitic stainless steel with a unique crystallographic lamellar microstructure via selective laser melting”; S. Sun, T. Ishimoto, K. Hagihara, Y. Tsutsumi, T. Hanawa, T. Nakano; Scriptia Materialia, 159, (2019) 89-93, discloses a method of forming a single-crystalline-like structure. A laser beam was scanned bidirectionally along an x-axis without rotation. The specimen fabricated at a higher energy density had columnar cells oriented at +/−45° only. The melt-pool shape formed at these high energy densities had a near keyhole shape. The authors believe that, due to the increased curvature of the melt pool in keyhole mode, lateral migration of the solid-liquid interface is dominant at the melt pool bottom and there would be little chance for cells to grow in the build direction at the bottom of the melt-pool. If vertically grown cells form by chance, their growth will be stopped by lateral solid-liquid interface migration. Fragments with (001) orientation along the build direction were partly observed in the lower part of the specimen fabricated under higher energy density, however, these did not extend through multiple melt-pools.

Although some nickel-based superalloys have been additively manufactured substantially crack-free, such as IN625 and IN718, the processing of other nickel-based superalloys, such as CM247LC, has not been so successful. The limited weldability of such superalloys is in part attributed to the high fractions of the strengthening gamma-prime phase (driven by the Al and Ti content). Increasing content increases the crack susceptibility, which is further amplified during rapid solidification as occurs in additive manufacturing.

### SUMMARY OF INVENTION

According to a first aspect of the invention there is provided an additive manufacturing method wherein an object is formed by selectively solidifying layers of powder with at least one energy beam, the method comprising forming the object from a nickel-based superalloy, wherein exposure parameters and an exposure pattern for the at least one energy beam result in a directionally solidified microstructure with columnar grains aligned with a build direction, perpendicular to the layers.

It has been found that, for certain nickel-based superalloys, the formation of the object with columnar grains aligned with the build direction aid in the formation of an object having a reduced number of cracks compared to exposure parameters and an exposure pattern that form a microstructure having grains aligned in other directions.

For example, the nickel-based superalloy may contain 7.5-12% W, 6-23% Cr, 3-8% Al and 8-12% Co. Other common additions may be Ta, Hf, Ti, Mo, Zr, B, Si, Mn, C and Nb. In broad terms, the elemental additions in Ni-base superalloys can be categorized as being i) γ formers and strengtheners—elements that tend to partition to the γ matrix, ii) γ′ formers and strengtheners—elements that partition to the γ′ precipitate, iii) carbide formers, and iv) elements that segregate to the grain boundaries. Elements which are considered γ formers are Group V, VI, and VII elements such as Co, Cr, Mo, W and Fe. The atomic diameters of these alloys are only 3-13% different from that of Ni (the primary matrix element). γ′ formers come from group III, IV, and V elements and include Al, Ti, Nb, Ta and Hf. The atomic diameters of these elements differ from Ni by 6-18%. The main carbide formers are Cr, Mo, W, Nb, Ta and Ti. The primary grain boundary elements are B, C, Zr and Hf. Their atomic diameters are 21-27% different from that of Ni. Re and Ru and have the effect of increasing the liquidus and solidus temperature of the alloy.

The chemical composition of the nickel-based alloy by weight % may comprise: 9.3-9.7W, 9.0-9.5Co, 7.5-8.5Cr, 5.4-5.7A1, 3.1-3.3Ta, 1.4-1.6Hf, 0.6-0.9Ti, 0.4-0.6Mo, 007-0.015Zr, 0.01-0.02B with a carbon concentration of around 0.07-0.09 wt % and a balance of Ni. The nickel-based alloy may also comprise any one or more up to the maximum weight percentage: Si 0.03 max, Mn 0.10 max, P 0.005 max, Fe 0.2 max, Cu 0.05 max, Nb 0.10 max, and/or any one or more following up to the maximum ppm: S 20 ppm max., Mg 80 ppm max., Pb 2 ppm max., Se 1.0 ppm max., Bi 0.3 ppm max., Te 0.5 ppm max, Tl 0.5 ppm max, [N] ppm 15 max, [O] ppm 10 max and N_{v3B} 2.15 max.

The chemical composition of the nickel-based alloy by weight % may substantial consist of: 9.3-9.7W, 9.0-9.5Co, 7.5-8.5Cr, 5.4-5.7A1, 3.1-3.3Ta, 1.4-1.6Hf, 0.6-0.9Ti, 0.4-0.6Mo, 007-0.015Zr, 0.01-0.02B with a carbon concentration of around 0.07-0.09 wt % and a balance of Ni, any one or more (or none) of the following up to the maximum weight percentage: Si 0.03 max, Mn 0.10 max, P 0.005 max, Fe 0.2 max, Cu 0.05 max, Nb 0.10 max, and any one or more (or none) of following up to the maximum ppm: S 20 ppm max., Mg 80 ppm max., Pb 2 ppm max., Se 1.0 ppm max., Bi 0.3 ppm max., Te 0.5 ppm max, Tl 0.5 ppm max, [N] ppm 15 max, [O] ppm 10 max and N_{v3B} 2.15 max.

The nickel-based alloy may be CM 247 or CM 247 LC.

The term “a directionally solidified microstructure with columnar grains aligned with a build direction” means a major axis of each columnar grain is within +/−15° of the build direction. The term “columnar grain” as used herein means a continuous elongate volume of solidified material with the same crystallographic orientation, wherein a major axis is greater than 5 μm. For example, nano- and anti-grains are not within the meaning of “columnar grains” as used herein. “Major axis” refers to the major axis of an ellipse fitted to the columnar grain. The exposure parameters and the exposure pattern may be such that, for five EBSD images of different regions of the solidified material having an area of 200 μm by 200 μm, greater than 90%, 91%, 92%, 93%, 94%, 95%, 96%, 97%, 98% or 99% of the columnar grains are aligned with the build direction.

A crystallographic orientation of the columnar grains may be predominantly <100>. The exposure parameters and the exposure pattern for the at least one energy beam may result in a percentage of the object having columnar grains with a <100> crystallographic orientation that deviates from the build direction by more than 20° of less than 30%. It has been found that objects that deviate above this 30% threshold can result in an unacceptable number of cracks.

It has been found that both a physical orientation of the columnar grains and a crystallographic orientation of the columnar grains contribute to a reduction or elimination of cracks within an object formed of a nickel-superalloy, such as CM247 LC.

The exposure parameters and exposure pattern may be such that melt pools are formed in transition or conduction mode. It will be understood that “conduction mode” as used herein means that the energy of the energy beam is coupled into the powder bed primarily through heat conduction creating a melt pool having a width equal to or greater than twice its depth (a ratio of depth to width of less than 0.5). This is to be contrasted with keyhole mode in which a hole is formed in the melt pool where material is vaporised by exposure to the energy beam. A melt pool formed in keyhole mode has a deep, narrow profile with a ratio of depth to width of greater than 1.5. A transition mode exists between the conduction mode and the keyhole mode, wherein the energy does not dissipate quickly enough, and the processing temperature rises above the vaporisation temperature. A depth of the melt pool increases, and penetration of the melt pool can start. Preferably, the method comprises exposing the layer to the at least one energy beam to form melt pools in a conduction or transition mode having a depth to width ratio of less than 1.5, preferably, less than 1, more preferably less than 0.75 and most preferably less than or equal to 0.5.

The exposure parameters and exposure pattern of the at least one energy beam may be such that a solidification front velocity and/or cooling rate results in a refinement of the microstructure that disrupts a liquid film of molten material formed by irradiating the powder with the at least one energy beam. The exposure parameters and exposure pattern of the at least one energy beam may be such that a solidification front velocity and/or cooling rate is above a predetermined threshold. The cooling rate threshold may be above 1.4×10⁶K/s. The cooling rate may be 1.4×10⁶K/s to 1.5×10⁷ K/s.

The exposure pattern may include a geometrical arrangement of scan paths of the at least one energy beam between successive layers, wherein the same geometrical arrangement of scan paths is maintained between a plurality of pairs of successive layers. Maintaining a set geometrical arrangement of scan paths between successive layers may be required in order to achieve the directionally solidified microstructure and/or the crystallographic orientation. In a preferred embodiment, the geometrical arrangement is that the scan paths between successive layers are aligned. It will be understood that the terms “aligned” as used herein with respect to the scan paths means that, for regions of a layer that are solidified onto previously solidified material (rather than above powder) of a previous layer, each scan path directly overlies a scan path used to form the previously solidified region. In this way, the melt pools formed by scanning the at least one energy beam along the scan paths of successive layers stack directly above each other in the build direction facilitating the formation of columnar grains in the build direction. This is particularly the case for exposure parameters and exposure patterns that form melt pools in transition or conduction mode as the shallow parabolic shape of the melt pool results in columnar grains forming in the build direction around a centre of the melt pool. This is to be contrasted with the deeper melt pools formed in keyhole mode, which result in an increase in grain formation in a direction substantially perpendicular to the build direction.

The scan paths on successively melted layers may be parallel. The scan paths of a layer may be scanned bidirectionally, i.e. back and forth along consecutively scanned paths, or may be scanned unidirectionally. Unidirectional scanning may aid the dissipation of heat and therefore, maintenance of a required melt pool shape.

Each layer may have a layer thickness less than half an average (mean) melt pool depth, such as a melt pool depth averaged across at least 10 of the melt pools and preferably all the melt pools. Each layer may have a layer thickness of less than 50 micrometres, less than 40 micrometres or less than 30 micrometres. In one embodiment, the layer thickness is around 20 micrometres. It has been found that the required geometrical arrangement of melt pools can be achieved with such a layer thickness.

However, it will be understood that, for non-circular like energy beam profiles or rapidly moved (such as rapidly oscillating) energy profiles on a surface of the powder (for example as may be achieved using the additive manufacturing apparatus disclosed in WO2016/156824, which is incorporated herein in its entirety by reference), elongate melt pools may be formed transverse to a (primary) scanning direction, the elongate melt pools having a larger region in which columnar grains form in the build direction upon solidification. In such an embodiment, alignment of the scan paths between successive layers may be of less importance in order to achieve the directionally solidified microstructure.

The scan paths may be straight hatch lines. In one embodiment, the at least one energy beam is progressed along the scan paths for successive layers in the same direction. Progressing the energy beam along the scan paths in the same direction for successive layers may facilitate the formation of columnar grains in a common direction.

The energy beam or a one of the energy beams may be scanned continuously along each scan path (contrasted with the known point scanning technique, wherein an energy beam is progressed along a scan path by exposing a plurality of points separated by a point distance).

The exposure parameters may include power of the energy beam, scanning velocity of the energy beam, distance (referred to hereinafter as hatch distance) between the scan paths, point distance between points along the scan path and exposure time for each point (and optionally delay time between the point exposures) and/or spot size (or focal distance).

The object may be built so as to be connected to a build substrate. The build substrate may have a polycrystalline and/or multi-directionally solidified and/or amorphous microstructure. It has been found that the directionally solidified microstructure of the object can be formed independently of the microstructure of the substrate, although for a few initial layers the crystallographic microstructure may seed from the crystallographic microstructure of the build substrate.

According to a second aspect of the invention there is provided a powder bed fusion additive manufacturing apparatus comprising at least one scanner for scanning an energy beam across layers of a powder bed and a controller arranged to control the at least one scanner to carry out the method according to the first aspect of the invention.

According to a third aspect of the invention there is provided a data carrier having instructions stored thereon, wherein the instructions, when executed by a controller of a powder bed fusion additive manufacturing apparatus comprising at least one scanner for scanning an energy beam across layers of a powder bed, cause the controller to control the powder bed fusion additive manufacturing apparatus to carry out the method of the first aspect of the invention.

According to a fourth aspect of the invention there is provided a method of generating instructions for an additive manufacturing apparatus, the method comprising receiving a model of an object and generating instructions and generating scanning parameters for at least one energy beam to solidify layers of powder in a layer-by-layer manner, wherein the exposure parameters and exposure pattern of the at least one energy beam result in the object having a directionally solidified microstructure with columnar grains aligned with a build direction, perpendicular to the layers.

According to a fifth aspect of the invention there is provided a data carrier having instructions stored thereon, wherein the instructions, when executed by a processor, cause the processor to carry out the method of the fourth aspect of the invention.

The data carrier may be a suitable medium for providing a machine with instructions such as non-transient data carrier, for example a floppy disk, a CD ROM, a DVD ROM/RAM (including -R/-RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example signals sent over a wired or wireless network (such as an Internet download, an FTP transfer, or the like).

### DESCRIPTION OF THE DRAWINGS

FIG. 1 is a schematic view of a powder bed fusion additive manufacturing apparatus according to an embodiment of the invention;

FIG. 2 is a hatch exposure pattern used in a method according to an embodiment of the invention;

FIG. 3a shows a cross-section in a plane parallel to a build direction for a part built in CM 247 LC using an exposure pattern according to an embodiment of the invention, the image marked up to indicate the location of the melt pools; and FIG. 3b is an image obtained using electron backscatter diffraction (EBSD) showing the directional microstructure of the solidified material;

FIG. 4 is a schematic diagram of a melt pool arrangement that may be formed by an exposure pattern of the invention and the resultant grain directions;

FIG. 5 is a schematic diagram of a melt pool arrangement that may be formed by the exposure pattern that forms melt pools in a keyhole mode and the resultant grain directions;

FIG. 6 shows an image of a cross-section of a part in a plane parallel to a build direction for a part built in CM 247 LC using an exposure pattern according to an embodiment of the invention;

FIG. 7 shows an image of a cross-section of a part in a plane parallel to a build direction for a part built in CM 247 LC using an isolated point exposure pattern;

FIG. 8 is a processed EBSD image of a part built using a method of the invention showing the deviation angle of the columnar grains with respect to the build direction; and

FIG. 9 is a processed EBSD image of the part of FIG. 8 showing the grains whose <100> crystallographic directions deviate by less than 20° from the build direction.

### DESCRIPTION OF EMBODIMENTS

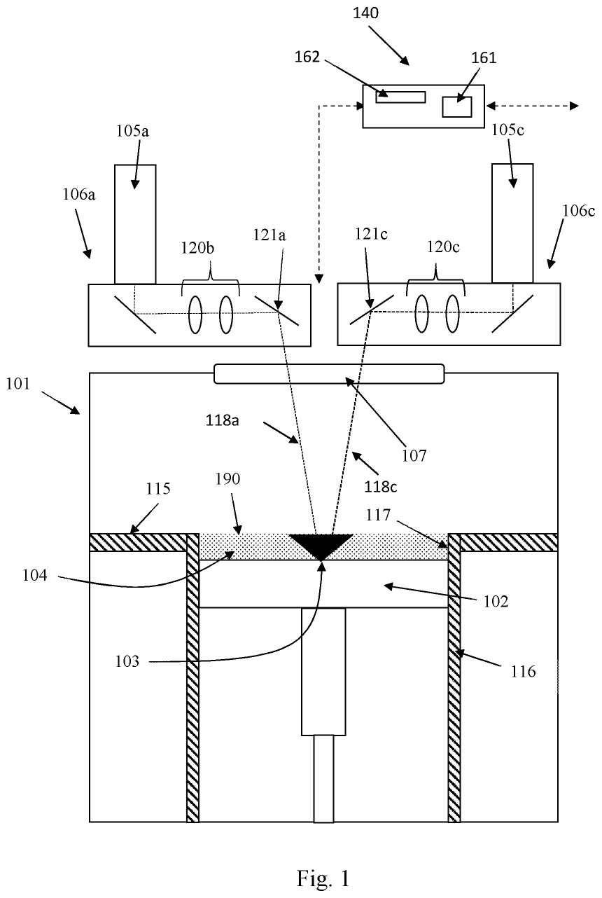

Referring to FIG. 1, a powder bed fusion additive manufacturing apparatus according to an embodiment of the invention comprises a build chamber 101 sealable from the external environment such that an inert atmosphere (in this embodiment, argon) can be maintained therein. Within the build chamber 101 are partitions 115, 116 that define a build sleeve 117. A build platform 102 is lowerable in the build sleeve 117. The build platform 102 supports a powder bed 104 and workpiece (part) 103 as the workpiece is built by selective laser melting of the powder. The platform 102 is lowered within the build sleeve 117 under the control of a drive (not shown) as successive layers of the workpiece 103 are formed.

Layers of powder 104 are formed as the workpiece 103 is built by a layer formation device, in this embodiment a dispensing apparatus and a wiper (not shown). For example, the dispensing apparatus may be apparatus as described in WO2010/007396. The dispensing apparatus dispenses powder onto an upper surface defined by partition 115 and is spread across the powder bed by the wiper. A position of a lower edge of the wiper defines a working plane 190 at which powder is consolidated. A build direction BD is perpendicular to the working plane 190.

A plurality of laser modules 105a, 105c generate laser beams 118a, 118c, for melting the powder 104, the laser beams 118a, 118c directed as required by a corresponding optical module (scanner) 106a, 106c. The laser beams 118a, 118c, enter through a common laser window 107. Each optical module comprises steering optics 121, such as two mirrors mounted on galvanometers, for steering the laser beam 118 in perpendicular directions across the working plane and focussing optics 120, such as two movable lenses for changing the focus of the corresponding laser beam 118. The scanner is controlled such that the focal position of the laser beam 118 remains in the working plane 190 as the laser beam 118 is moved across the working plane. Rather than maintaining the focal position of the laser beam in a plane using dynamic focusing elements, an f-theta lens may be used.

An inlet and outlet (not shown) are arranged for generating a gas flow across the powder bed formed on the build platform 102. The inlet and outlet are arranged to produce a laminar flow having a flow direction from the inlet to the outlet. Gas is re-circulated from the outlet to the inlet through a gas recirculation loop (not shown).

A controller 140, comprising processor 161 and memory 162, is in communication with modules of the additive manufacturing apparatus, namely the laser modules 105a, 105b, 105c, 105d, optical modules 106a, 106b, 106c, 106d, build platform 102, dispensing apparatus 108 and wiper 109. The controller 140 controls the modules based upon software stored in memory 162 as described below.

In use, a computer receives a geometric model, such as an STL file, describing a three-dimensional object to be built using the powder bed fusion additive manufacturing apparatus. The computer slices the geometric model into a plurality of slices to be built as layers in the powder bed fusion additive manufacturing apparatus based upon a defined layer thickness. In this embodiment, the defined layer thickness, L, is less than 30 micrometres and, preferably 20 micrometres.

The computer may comprise an interface arranged to provide a user input for selecting the material from which the object is to be built. The computer then selects exposure parameters from a database that are suitable for the identified material. A laser exposure pattern is then determined for melting areas of each layer to form the corresponding cross-section (slice) of the object. Based upon these calculations, the computer generates instructions that are sent to controller 140 to cause the additive manufacturing apparatus to carry out a build in accordance with a desired exposure strategy. For nickel-based superalloys, such as CM247 LC, the following exposure strategy is used.

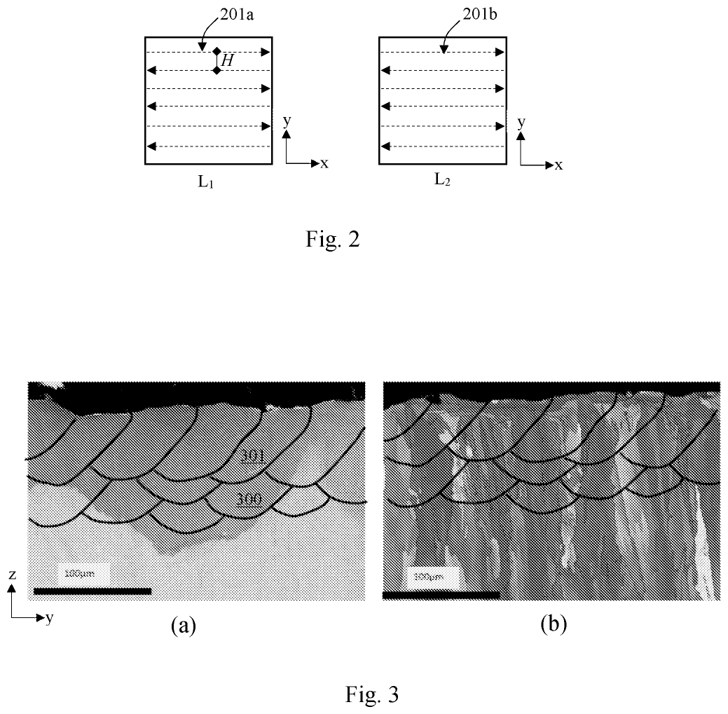

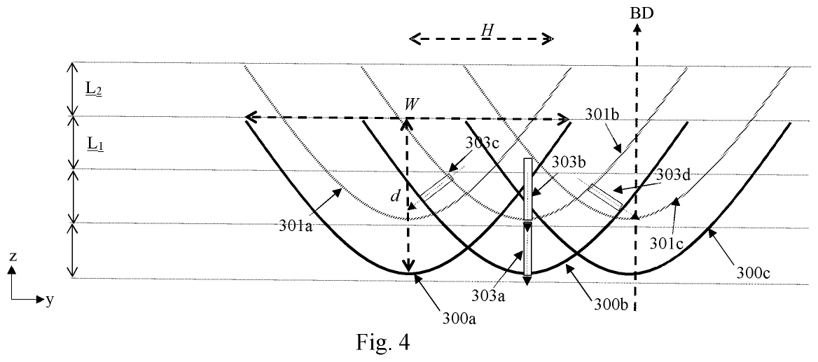

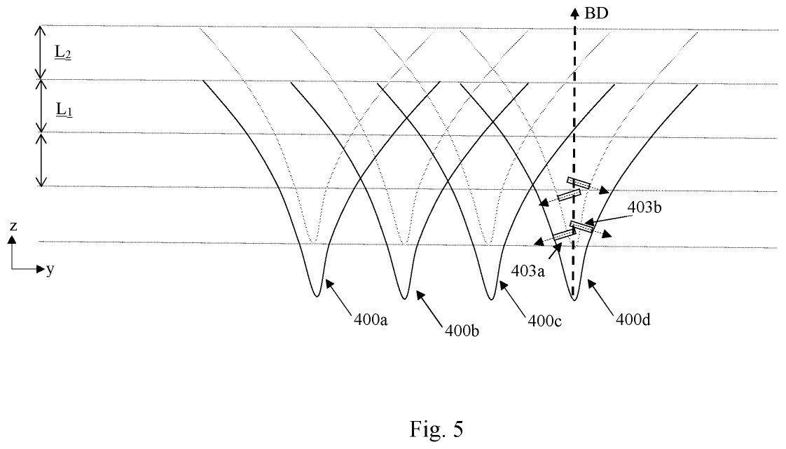

Referring to FIGS. 2 and 3, the laser beams are scanned along hatch lines 201 in each layer L₁, L₂ to form the object. The hatch lines 201a, 201b for every layer L1, L₂ are parallel and aligned in the z-direction such that a melt pool 301 in a layer L₂ is formed directly above the melt pool 300 of the immediately preceding layer L₁. This can be seen in FIGS. 4a and 5. The hatch lines 201a, 201b for a layer L₁, L₂ may all be scanned in the same direction (unidirectional scanning), or in alternate directions (bidirectionally) as shown in FIG. 2. An overlying hatch line 201b of a successive layer L₂ may be scanned in the same or opposite direction to the underlying hatch line 201a of the previous layer, L₁. An order in which the hatch lines 201a, 201b are scanned by the laser beam(s) may be the same or different between layers L₁, L₂. Furthermore, different ones of the hatch lines 201a, 201b may be scanned by different ones of the laser beams 118a, 118c.

The laser beam parameters, such as laser power, spot size on the powder (focal distance) and scan speed (for a point scanning regime, point distance, exposure time and delay time between exposures), are selected such that the melt pools formed by scanning the hatch lines 201a, 201b are formed in transition or conduction mode. The wider and shallower the melt pools 300, 301, whilst still melting through an entire layer L₁, L₂ of powder, the better. A hatch distance, H, between hatch lines 201a or 201b within a layer L₁, L₂ is selected such that solidified material formed by steeply inclined boundary regions (with respect to a plane of the powder layer) of the melt pools 300 are remelted by less steeply inclined boundary regions of melt pools 301 of the next layer L₂. For melt pools 300, 301 having a width, W, to depth, d, ratio of around 2:1, as shown in FIGS. 3a, 3b and 4, the hatch distance H may be less than 50% of the width, W, of the melt pool. For melt pools with higher width to depth ratios, the hatch distance, H, may be larger. Hatch distance may be selected based upon a function relating hatch distance to the width to depth ratio. A typical width to depth ratio of the melt pool for a particular set of laser beam parameters may be determined empirically. As can be seen from FIG. 3, the melt pools 300 width and depth will vary during processing within an expected range of values, but sufficient control can be maintained such that a desired geometrical relationship is achieved.

FIGS. 3a, 3b and 4 show images of cross-sections of the material perpendicular to the hatch line direction. Referring to FIG. 4, grains 303a to 303d grow in a direction of heat flow from the melt pool 300, 301 to surrounding material.

Accordingly, a direction of grain growth is influenced by a shape of the melt pool 300, 301. Grains 303a, 303b formed at a centre of the melt pool (a less steeply inclined boundary region) will grow in the build direction, BD, whereas grains 303c, 303d formed within steeply inclined boundary regions of the melt pool form in a direction inclined to the build direction BD. By forming the melt pools 301 of the next layer L₂ directly above the (now solidified) melt pools 300 of the previous layer L₁ and through an appropriate selection of the overlap between adjacent melt pools, the material forming grains 303c, 303d is remelted and the resultant solidification of the material replaces grains 303c, 303d with grains more closely inclined to the build direction, BD. Accordingly, a directionally solidified microstructure is produced.

This geometrical arrangement of the melt pools formed in conduction mode can be contrasted with melt pools formed in keyhole mode, as shown in FIG. 5, wherein the steeply inclined boundaries of the melt pools 400 result in the formation of grains 403a, 403b at a centre of the melt pool 400 at an angle to the build direction BD.

### EXAMPLE 1

A CM247 LC cube was formed using the above-mentioned exposure strategy in a Renishaw AM400 additive manufacturing apparatus. The following laser beam parameters were used:

Laser power: 140 W

Diameter of spot: 70 μm

Hatch distance: 50 μm

Point distance: 70 μm

Exposure time: 70 μs

Delay time: 0 s

The 0s delay time between each point exposure effectively causes the laser beam to be continuously scanned (i.e. without the laser beam being turned off) along the hatch lines.

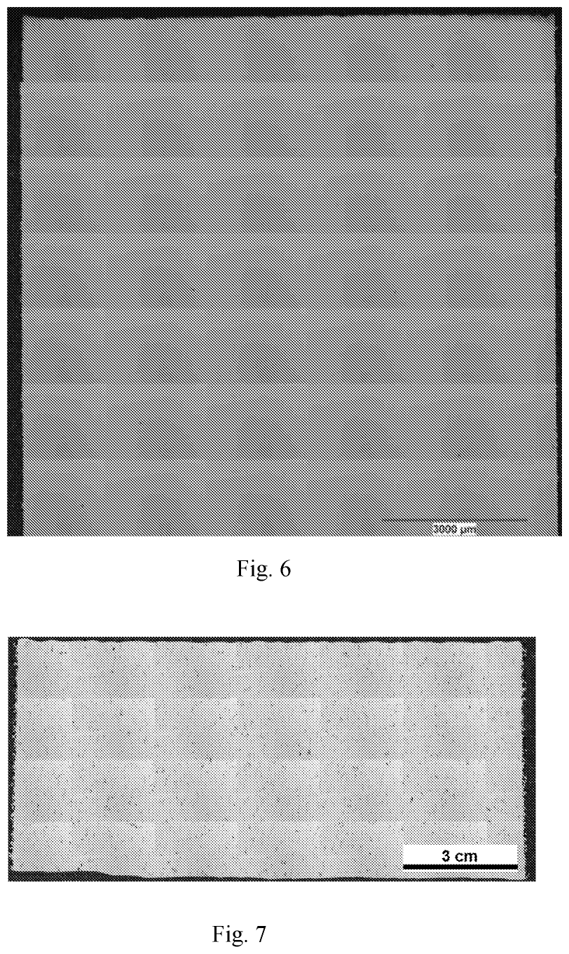

FIG. 6 is an image of a cross-sections of the cube in a working plane, parallel to the build direction. As can be seen, the part has a low crack density.

FIG. 8 shows the orientation of a major axis of the columnar grains with respect to the build direction. As can be seen, substantially all, if not all, of the columnar grains have their major axis oriented within 15° of the build direction.

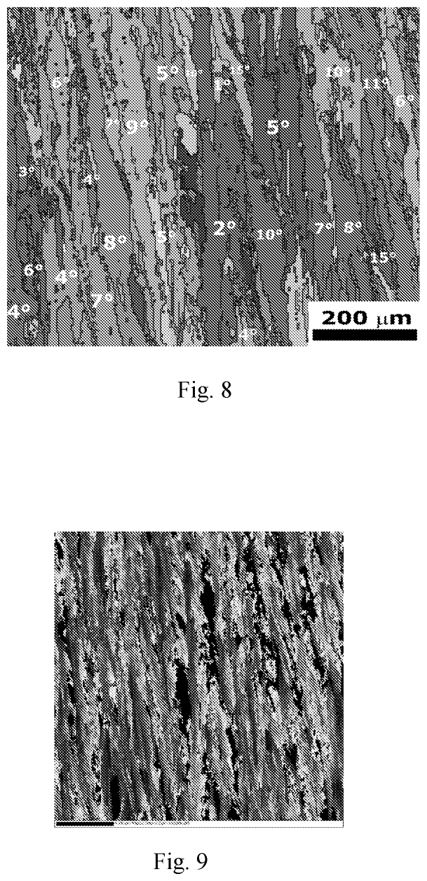

FIG. 9 shows the crystallographic orientation of these grains. Less than 30% of the grains have their <100> crystallographic directions deviated by more than 20° from the build direction.

### EXAMPLE 2

In example 2 the same laser beam parameters were used but with single isolated exposures. FIG. 7 is an image of a cross-section of the cube in a working plane, parallel to the build direction. As can be seen, the part has a significantly higher crack density compared to the part of example 1.

It will be understood that alterations and modifications may be made to the embodiments without departing from the invention as described herein. For example, in thin sectioned regions of a cross-section to the solidified, the scan paths and/or laser parameters may be modified to ensure that heat does not accumulate, which otherwise could result in the melt pool profile diverging from the required shape.

1. An additive manufacturing method wherein an object is formed by selectively solidifying layers of powder with at least one energy beam, the method comprising forming the object from a nickel-based superalloy, wherein exposure parameters and an exposure pattern for the at least one energy beam result in the object having a directionally solidified microstructure with columnar grains aligned with a build direction, perpendicular to the layers, and a composition of the nickel-based alloy by weight % comprises: 9.3-9.7W, 9.0-9.5Co, 7.5-8.5Cr, 5.4-5.7A1, 3.1-3.3Ta, 1.4-1.6Hf, 0.6-0.9Ti, Mo 0.4-0.6, 007-0.015Zr, 0.01-0.02B with a carbon concentration of around 0.07-0.09 wt % and a balance of Ni.

2. An additive manufacturing method according to claim 1, wherein the nickel-based alloy also comprises any one or more of the following by weight percentage: Si 0.03 max, Mn 0.10 max, P 0.005 max, Fe 0.2 max, Cu 0.05 max, Nb 0.10 max, and/or any one or more following up to the maximum ppm: S 20 ppm max., Mg 80 ppm max., Pb 2 ppm max., Se 1.0 ppm max., Bi 0.3 ppm max., Te 0.5 ppm max, Tl 0.5 ppm max, [N] ppm 15 max, [O] ppm 10 max and N_{v3B} 2.15 max.

3. An additive manufacturing method according to claim 1, wherein the nickel-based alloy is CM 247 or CM 247 LC.

4. An additive manufacturing method according to claim 1, wherein a crystallographic orientation of the columnar grains is predominantly <100>.

5. An additive manufacturing method according to claim 4, wherein the exposure parameters and the exposure pattern for the at least one energy beam result in a percentage of the object having columnar grains with a <100> crystallographic orientation that deviates from the build direction by more than 20° of less than 30%.

6. An additive manufacturing method according to claim 1, wherein the exposure parameters and exposure pattern are such that melt pools are formed in transition or conduction mode.

7. An additive manufacturing method according to claim 1, wherein the exposure parameters and exposure pattern of the at least one energy beam are such that a cooling rate of the melt pool is above a predetermined threshold, such as above 1.4×10⁶K/s.

8. An additive manufacturing method according to claim 1, wherein the exposure pattern includes a geometrical arrangement of scan paths of the at least one energy beam between successive layers, wherein the same geometrical arrangement of scan paths is maintained between a plurality of pairs of successive layers.

9. An additive manufacturing method according to claim 1, wherein, the geometrical arrangement is such that the scan paths between successive layers are aligned.

10. An additive manufacturing method according to claim 1, wherein the geometrical arrangement is such that the melt pools formed by scanning the at least one energy beam along the scan paths of successive layers stack directly above each other in the build direction facilitating the formation of the columnar grains in the build direction.

11. An additive manufacturing method according to claim 1, wherein the scan paths on successively melted layers are parallel.

12. An additive manufacturing method according to claim 1, wherein each layer has a layer thickness less than half a mean melt pool depth.

13. An additive manufacturing method according to claim 1, wherein the scan paths are straight hatch lines.

14. An additive manufacturing method according to claim 1, wherein the at least one energy beam is scanned continuously along each scan path.

15. A powder bed fusion additive manufacturing apparatus comprising at least one scanner for scanning an energy beam across layers of a powder bed and a controller arranged to control the at least one scanner to carry out the method according to claim 1.

16. A data carrier having instructions stored thereon, wherein the instructions, when executed by a controller of a powder bed fusion additive manufacturing apparatus comprising at least one scanner for scanning an energy beam across layers of a powder bed, cause the controller to control the powder bed fusion additive manufacturing apparatus to carry out the method of claim 1.

17. A method of generating instructions for an additive manufacturing apparatus, the method comprising receiving a model of an object and generating instructions and generating scanning parameters for at least one energy beam to solidify layers of powder in a layer-by-layer manner, wherein the exposure parameters and exposure pattern of the at least one energy beam result in the object having a directionally solidified microstructure with columnar grains aligned with a build direction, perpendicular to the layers, when the object is formed from a nickel-based alloy having a composition by weight % comprising: 9.3-9.7W, 9.0-9.5Co, 7.5-8.5Cr, 5.4-5.7Al, 3.1-3.3Ta, 1.4-1.6Hf, 0.6-0.9Ti, Mo 0.4-0.6, 007-0.015Zr, 0.01-0.02B with a carbon concentration of around 0.07-0.09 wt % and a balance of Ni.

18. A data carrier having instructions stored thereon, wherein the instructions, when executed by a processor, cause the processor to carry out the method of claim 17.
